(19) United States
(12) Patent Application Publication
(10) Pub. No.: US 2014/0117027 A1
(43) Pub. Date: May 1, 2014

(54) CONTAINER WITH AGGREGATING FEATURE

(71) Applicant: DAVID C. ULSTAD, Dublin, OH (US)

(72) Inventor: DAVID C. ULSTAD, Dublin, OH (US)

(73) Assignee: ABBOTT LABORATORIES, ABBOTT PARK, IL (US)

(21) Appl. No.: 14/033,021

(22) Filed: Sep. 20, 2013

Related U.S. Application Data
(60) Provisional application No. 61/703,303, filed on Sep. 20, 2012.

(51) Int. Cl. A61J 9/00; B65D 1/40

(52) U.S. Cl. CPC A61J 9/00; B65D 1/40
USPC 220/600

(57) ABSTRACT

A container for storing a liquid. The container includes at least one side wall and a bottom wall defining an interior space. The bottom wall has an interior surface which is defined by at least a first surface and a second surface. The first surface aggregates a residual amount of the liquid. The second surface has a slope toward the first surface for directing a residual amount of the liquid toward the first surface

### CROSS-REFERENCE TO RELATED APPLICATION

This application claims the benefit of and priority to U.S. Provisional Patent Application Ser. No. 61/703,303, entitled CONTAINER WITH AGGREGATING FEATURE and filed Sep. 20, 2012, the entire disclosure of which is incorporated herein by reference, to the extent that it is not conflicting with the application.

### BACKGROUND

Enteral liquid nutrition products are an essential part of the diet of an infant. The products may be manufactured in a factory, such as for example, infant formula, or produced naturally by the human body, such as for example, breast milk or colostrum. Enteral liquid nutrition products are often collected, transferred and stored in a variety of containers. Certain containers are designed especially for this purpose, and are popular in hospital and home applications.

When an adult provider is ready to use a stored amount of an enteral liquid nutrition product, the liquids often are presented to a patient via a feeding syringe, or the liquids are transferred from the storage container to a feeding bottle with a syringe. For example, a nurse may use a syringe to collect breast milk from a container, and feed a premature infant with the same syringe.

Conventional containers have interior bottom surfaces that are flat, shallow concave, or shallow convex. For a syringe to draw the last of the liquid out of a container, the liquid layer must be deep enough to keep the syringe tip fully submerged. If not, the syringe will lose suction. Once the syringe loses suction, no more liquid can be drawn out with that particular syringe. Any attempt by the nurse to tilt the container up on an edge to direct liquid to the edge of the container may make the liquid depth somewhat deeper to accommodate further withdrawal by a syringe, but this solution typically results in incomplete suction of the residual liquid.

### SUMMARY

The application describes a container for use in storage of a liquid, such as for example, a container suitable for use in temporarily storing human breast milk.

In an exemplary embodiment, a container has at least one side wall and a bottom wall defining an interior space. The bottom wall has an interior surface which is advantageously shaped to aggregate residual liquid remaining in the container after the bulk of the liquid has been removed.

Further features and advantages of the invention will become apparent from the following detailed description made with reference to the accompanying drawings.

### BRIEF DESCRIPTION OF THE DRAWINGS

Features and advantages of the general inventive concepts will become apparent from the following detailed description made with reference to the accompanying drawings.

FIG. 1 is a front view, partially in section, of a prior art container;

FIG. 2 is a front view of a container;

FIG. 3a is a bottom perspective view of the container of FIG. 2;

FIG. 3b is a top view of the container of FIG. 2;

FIG. 4a is a front sectional view of the container of FIG. 2;

FIG. 4b is an enlarged view of the designated circular area of FIG. 4a;

FIG. 5a is a front sectional view of another container;

FIG. 5b is an enlarged view of the designated circular area of FIG. 5a;

FIG. 6a is a front sectional view of the container of FIG. 2, shown with a syringe inserted into the container;

FIG. 6b is an enlarged view of the designated circular area of FIG. 6a;

FIG. 7 is a bottom perspective view of another container;

FIG. 8 is a front sectional view of the container of FIG. 7, shown along the line 8-8 of FIG. 7;

FIG. 9 is a top view of the container of FIG. 7;

FIG. 10 is a bottom perspective view of another container;

FIG. 11 is a front sectional view of the container of FIG. 10, shown along the line 11-11 of FIG. 10;

FIG. 12 is a top view of the container of FIG. 10;

FIG. 13 is a bottom perspective view of another container;

FIG. 14 is a front sectional view of the container of FIG. 13, shown along the line 14-14 of FIG. 13; and

FIG. 15 is a top view of the container of FIG. 13.

### DETAILED DESCRIPTION

This Detailed Description merely describes exemplary embodiments in accordance with the general inventive concepts and is not intended to limit the scope of the invention or the claims in any way. Indeed, the invention as described by the claims is broader than and unlimited by the exemplary embodiments set forth herein, and the terms used in the claims have their full ordinary meaning

The general inventive concepts will now be described with occasional reference to the exemplary embodiments of the invention. This general inventive concept may, however, be embodied in different forms and should not be construed as limited to the embodiments set forth herein. Rather, these embodiments are provided so that this disclosure will be thorough and complete, and will fully convey the scope of the general inventive concepts to those skilled in the art.

Unless otherwise defined, all technical and scientific terms used herein have the same meaning as commonly understood by one of ordinary skill in the art encompassing the general inventive concepts. The terminology set forth in this detailed description is for describing particular embodiments only and is not intended to be limiting of the general inventive concepts. As used in this detailed description and the appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, percentages and so forth as used in the specification and claims are to be understood as being modified in all instances by the term “about.” Accordingly, unless otherwise indicated, the numerical properties set forth in the specification and claims are approximations that may vary depending on the suitable properties sought to be obtained in embodiments of the invention. Notwithstanding that the numerical ranges and parameters setting forth the broad scope of the general inventive concepts are approximations, the numerical values set forth in the specific examples are reported as precisely as possible. Any numerical values, however, inherently contain certain errors necessarily resulting from error found in their respective measurements.

The term residual is used herein to describe an amount of liquid remaining in a container after the bulk of the liquid has been removed. The specific amount remaining may vary and is a factor of several variables, including, for example, the amount of original liquid in the container, the viscosity of the liquid, and the bulk removal technique. Further, the residual amount refers to the amount remaining in a container after the bulk amount has been removed by conventional techniques, and before any cleaning, drying, or other non-recovery techniques have been used to remove liquid.

For liquid nutritional products like breast milk, colostrum, or manufactured infant formula, users place high value on these products, both economical and emotional. This value is especially high when the product is colostrum, in which a mother can only produce for a limited time. Thus, wasting even a few drops can be disturbing to the user. When these products are stored and transferred between multiple containers, a user desires to literally use every last drop.

The invention is directed to a container with drainage and aggregating features to collect, store or mix enteral nutrition products. For example, breast milk may be stored within the container. The drainage feature guides the breast milk to a common aggregating region, such as a reservoir, where the liquid can be effectively collected by a removal instrument, such as for example, a syringe. The aggregating region may be at the lowest point in the container, with the container positioned as a user would insert a syringe for withdrawal of liquid. The shape and size of the aggregating region may mirror that of the tip of a syringe to allow the end of the syringe to remain submerged below the residual liquid at the aggregating point. With an aggregating region designed closely to that of a syringe tip, a syringe may withdraw the liquid from the aggregating region without the user having to reposition the container on its edge or side in an effort to make the residual liquid depth deep enough to submerge the collection tip of a syringe.

The application describes a container for use in storing liquids, such as for example, a container suitable for use in storing pumped breast milk. The container provides an interior bottom surface advantageously shaped to aggregate residual liquid remaining in the container after the bulk of the liquid has been removed. The container further offers an interior bottom surface advantageously shaped to allow insertion of a syringe tip below the level of a residual liquid amount.

One embodiment features a container for storing a liquid. The container includes at least one side wall and a bottom wall. The walls define an interior space for storing a liquid. The bottom wall has an interior surface defined by at least two portions, a first surface and a second surface. The first surface is shaped and oriented in a way to aggregate a residual amount of the liquid remaining in the container after a bulk amount of the liquid has been removed. The second surface has a slope toward the first surface for directing a residual amount of the liquid toward the first surface.

Another embodiment features a sealable container for storage and removal of the liquid. The container includes at least one side wall and a bottom wall. The walls define an interior space for storing a liquid. The bottom wall has an interior surface defined by at least two portions, a reservoir and a collecting surface. The reservoir is shaped and oriented in a way to aggregate a residual amount of the liquid remaining in the container after a bulk amount of the liquid has been removed. The collecting surface is sloped to direct a residual amount of the liquid toward the reservoir. The collecting surface is disposed around at least part of the reservoir. The reservoir and the collecting surface are separated by an edge. The term edge is used to mean a transition point from one surface to another surface. For example, the edge may be a hard break from one flat surface to another flat surface, or it may be a rounded shoulder between two surfaces in which one of the two surfaces may be arcuate. An edge can also be a rounded shoulder between two flat surfaces, such as a flat surface and a sloping surface, or an arcuate surface and a sloping surface. Further, the edge may be a break from one arcuate surface having a specific mathematical definition to another arcuate surface having a specific and different mathematical definition. As described herein, in some embodiments the slope of the interior surface increases at the edge in a direction toward the first surface.

Another embodiment features an system for storage of a liquid. The system includes an instrument and a container. The instrument has a liquid-receiving opening at a distal end, and is operable to remove liquid from the container. The container includes at least one side wall and a bottom wall defining an interior space. The bottom wall has an interior surface defined by at least two portions, a reservoir and a collecting surface. The reservoir is shaped and oriented in a way to aggregate a residual amount of the liquid remaining in the container after a bulk amount of the liquid has been removed. The collecting surface is sloped to direct a residual amount of the liquid toward the reservoir. The reservoir is cooperatively shaped relative to the distal end of the instrument, such that the instrument may be inserted into the reservoir to a depth below a liquid level within the reservoir. In other words, the syringe tip can insert essentially to the bottom surface of the reservoir and maintain suction until essentially all the residual liquid has been removed. The reservoir and the collecting surface are separated by an edge, and a slope of the interior surface increases at the edge in a direction toward the reservoir.

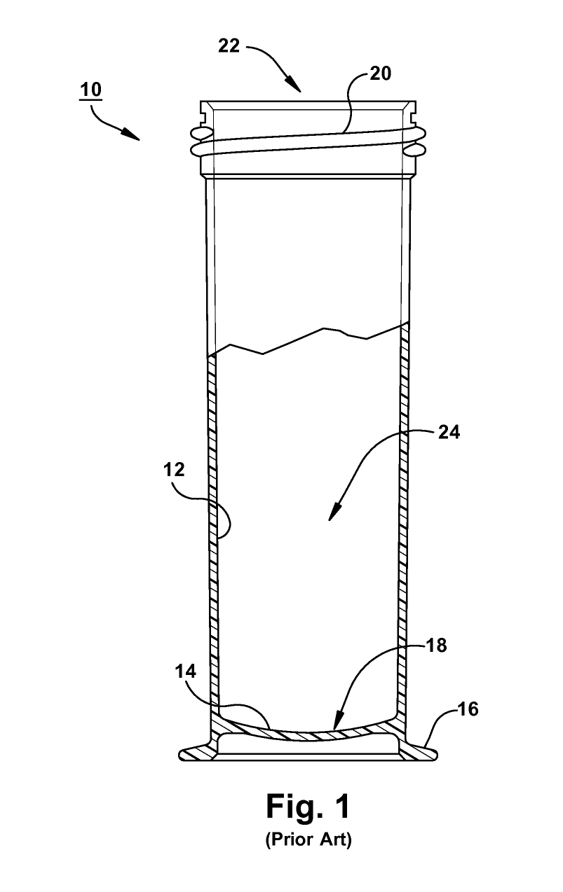

Referring now to the drawings, FIG. 1 is a front view, partially in section, of a prior art container 10. The container is shaped to hold a volume of pumped breast milk within an interior space 24, which is defined by a circular sidewall 12 and a bottom wall 14. The container 10 may rest upright on a flat surface by benefit of a flanged base 16. The container includes threads 20 which allow a removable cap to be manually attached to the container by a user to cover an opening 22 through which breast milk may be added or removed.

The prior art container 10 includes an interior bottom surface 18 which is slightly concave relative to the interior space 24. Other prior art containers may have a flat surface or may have a slightly convex surface. The concave pattern is consistent throughout the bottom surface 18 and makes removal of residual liquid with a syringe difficult. The depth of any residual liquids is shallow and makes it very difficult for a user of a syringe to maintain the syringe tip opening below the surface of the residual liquid. Residual liquid is frequently lost is a container of this or similar design. The same submersion problems exist with a container having a flat bottom surface or a slightly convex surface.

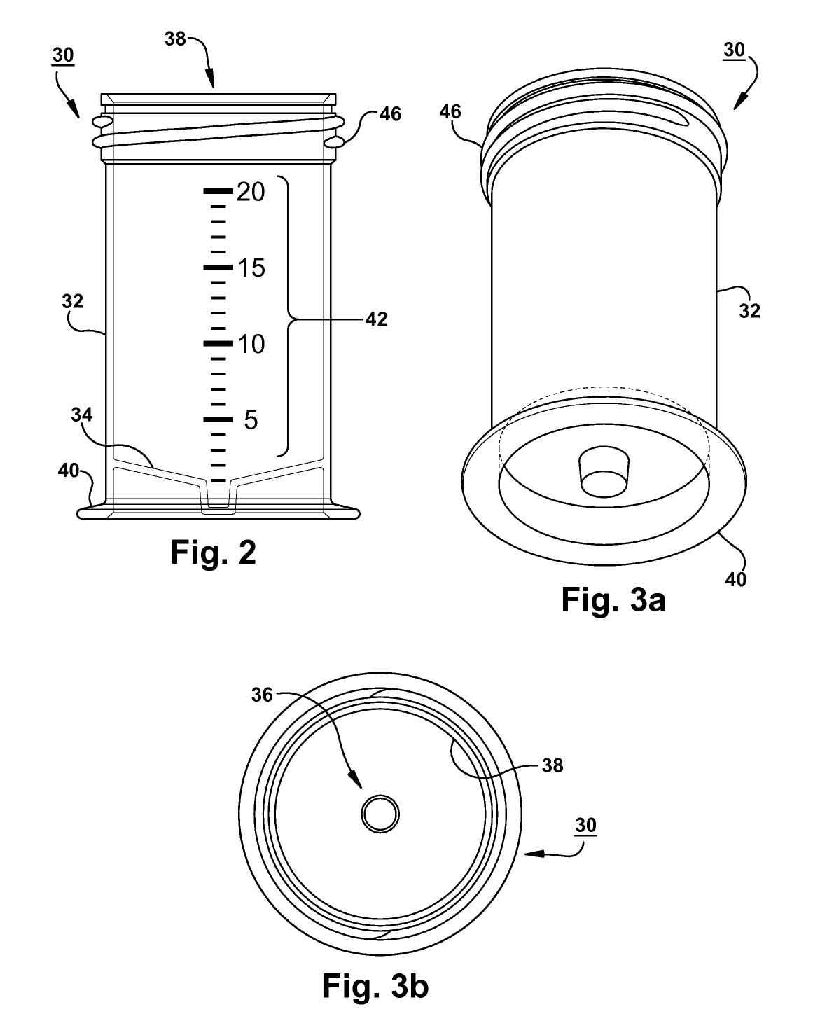

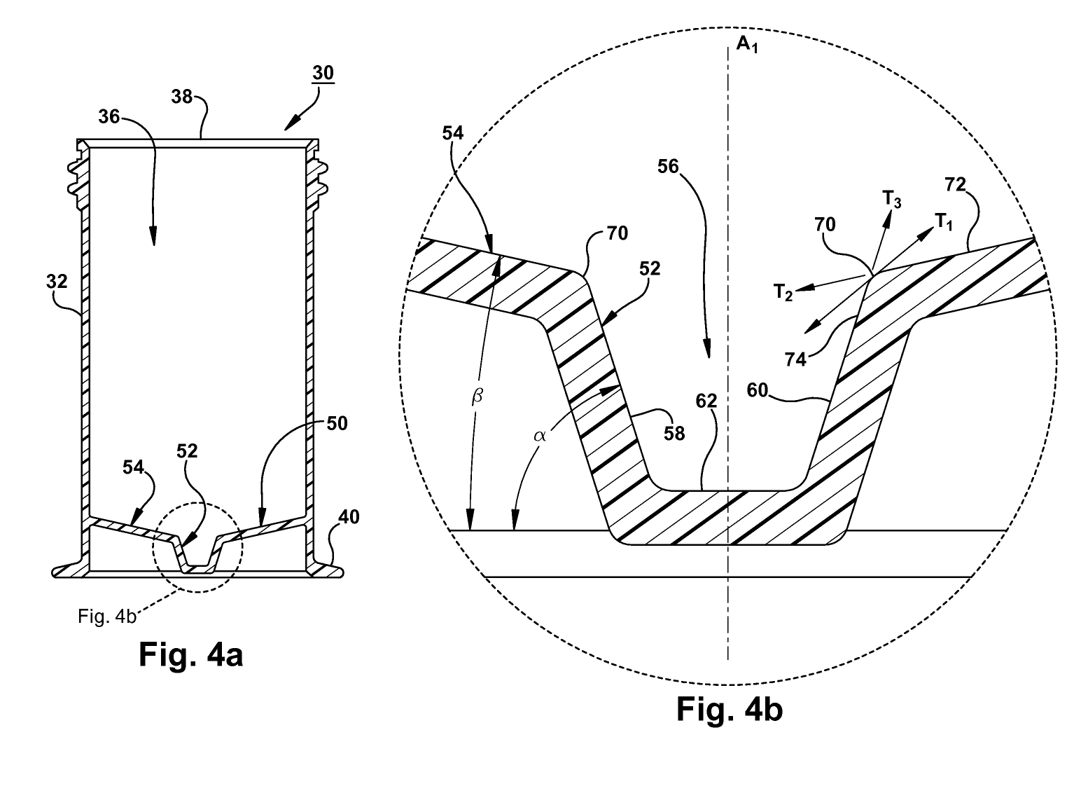

Referring now to FIG. 2, a front view of an exemplary container 30 is shown. The container 30 is arranged for use in storing breast milk, but this container and other embodiments discussed herein can be used for the storage of any type of infant liquid nutrition product, and further, for any general liquid nutrition product, or any liquid which requires temporary storage in a container prior to delivery to a recipient, such as for example, a medicine which is mixed into a liquid just prior to use. The container 10 is formed of molded hard plastic, but the invention may be practiced with the use of any suitable material, and manufactured by any suitable process. A bottom perspective view and a top view of the container are shown in FIGS. 3a and 3b, respectively. Further detail of the exemplary container 30 is illustrated in FIG. 4a, which is a front sectional view of the container 30, and in FIG. 4b, which is an enlarged view of the designated circular area of FIG. 4a.

The container 30 is shaped for ease and efficiency of mixing, filling and removing liquid nutritional products. The container includes a sidewall 32 and a bottom wall 34. The two walls 32, 34 define at interior space 36 accessible through a top opening 38. The container may conveniently stand upright on a horizontal surface by balancing on a flanged base 40. Graduated markings 42 are included along the height of the container 30. The container includes threads 46 which allow a removable cap (not shown) to be manually attached to the container by a user to cover the opening 38.

A bottom wall has an interior surface with features which limit the amount of lost residual breast milk. Referring now to FIGS. 4a and 4b, the interior surface 50 is defined by at least two portions, a first surface 52 at the center of the container and a second surface 54 near the sidewall of the container. As illustrated, the first surface is positioned deeper within the interior space than the second surface. The first surface 52 is arranged to aggregate a residual amount of the liquid after a bulk of the liquid has been removed. In this exemplary container, the first surface 52 defines a reservoir 56 in which residual liquid may be held for removal. The reservoir 56 is formed by steep flat walls 58, 60 and a bottom wall 62.

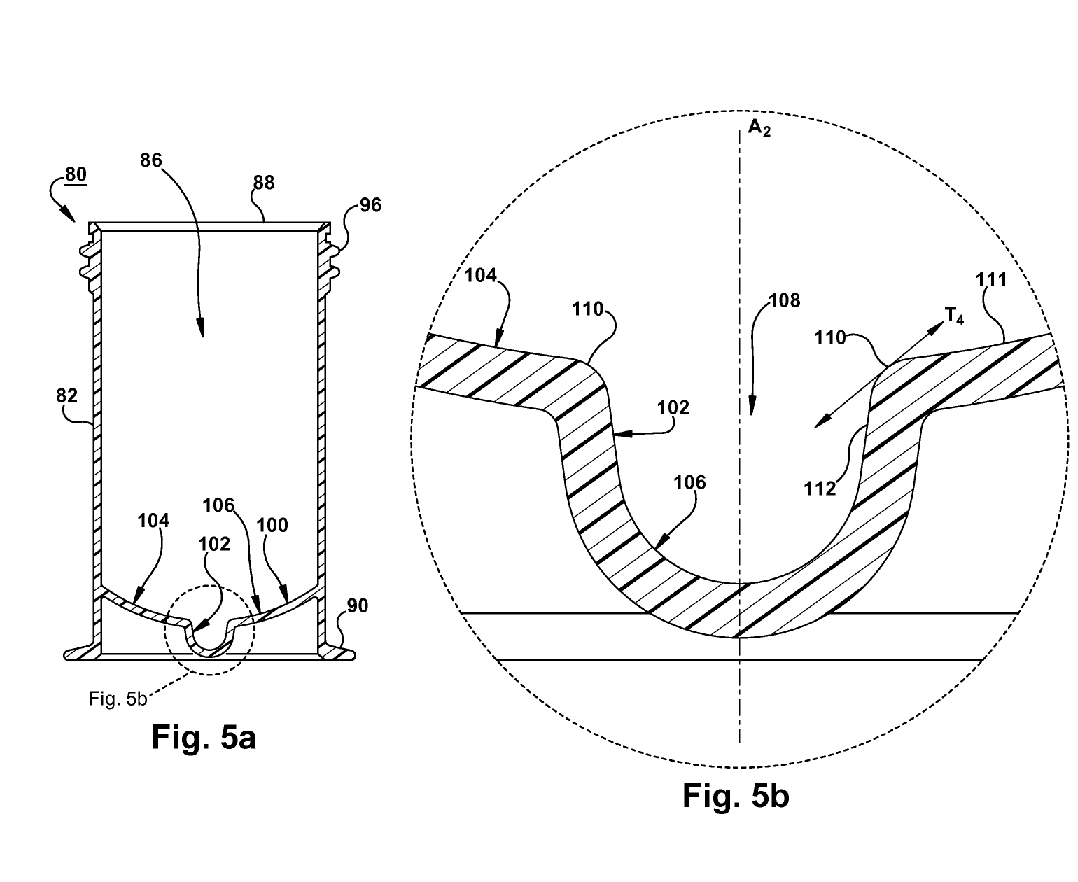

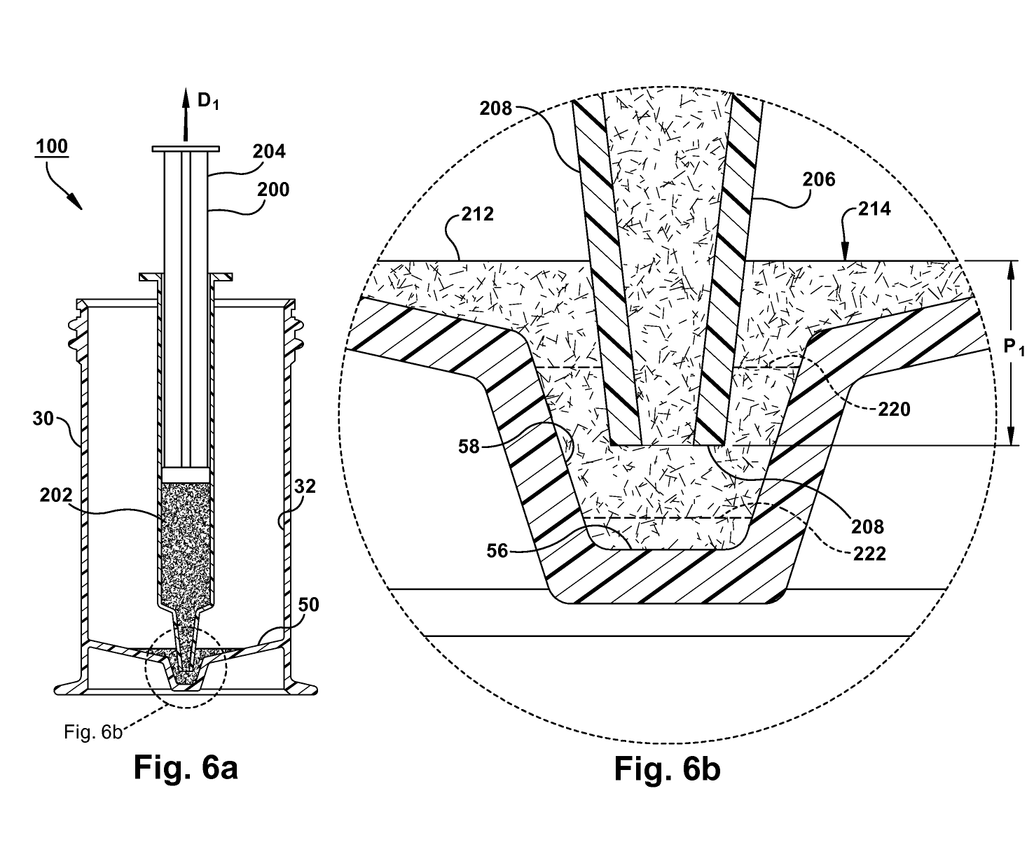

The reservoir is of sufficient size to collect the residual liquid within the container. An exemplary reservoir may be of any suitable size in light of the typical amount of residual fluid for a particular container size, such as for example, 50 micro liters or more in size (however, the reservoir may be of any desired size or shape. The reservoir may be formed with flat, steep walls as shown in FIG. 4b, formed with concave walls as shown in FIG. 5b, or formed with a combination of flat and arcuate walls. To be discussed herein, the reservoir is advantageously shaped to accept insertion of a syringe tip, as best seen in FIG. 6b, to a depth below the level of any aggregated residual liquid.

The second surface 54 has a downward slope toward the first surface 52 for directing a residual amount of the liquid toward the first surface 52. In the exemplary container 30 shown in FIGS. 2-4b, the second surface 54 surrounds the first surface 52 and, as best seen in FIGS. 3b and 4b, the second surface 54 and the reservoir are concentric about a longitudinal axis A₁ of the container. After the bulk of liquid within the interior space 36 is removed by a syringe or other method, residual liquid is forced down the generally vertical sidewall 32 by gravity and onto the second surface 54, which acts as a collecting surface. Gravity will continue to force residual liquid which gathers on the collecting surface 54 both downward and inward toward the centrally located reservoir 56.

The second or collecting surface 54 and the reservoir-defining surface 52 are separated by an edge. As shown in FIG. 4b, the edge 70 is a rounded shoulder between the two surfaces 52, 54. At the edge 70, the slope of the entire interior surface 50 increases in a direction toward the first surface 52. In other words, the slope of the entire interior surface 50 is steeper just to the inward side of the edge as compared to just to the outward side. For example, and as shown in FIG. 4b, a point 72 on the second surface 54 has a slope not as steep as a point 74 on the first surface 52 of the reservoir 56.

This arrangement is further illustrated by an illustration and discussion of tangents of the slope at various points along the entire interior surface 50, such as for example, the tangent at points on or near the edge 70. In FIG. 4b, a point 72 is located just to the outside on the edge 70 and point 74 is located just to the inside of the edge 70. In this arrangement, tangent T₂ at point 72 on the collecting surface is less steep the tangent T₁ at a point in the middle of the edge 70, and tangent T₁ at a point in the middle of the edge 70 is less steep than tangent T₃ at point 74 on the first surface. In the exemplary container 30, the slope of tangent T₃ at point 74 on the first surface is at least 1.5 times the slope of tangent T₂ at point 72 on the second surface. It should be apparent to one with skill in the art that the ratio between tangents at points on the first surface and points of the second surface may vary, and may be more or less than 1.5 in the practice of this invention.

Referring still to FIG. 4b, the second surface 54 is shaped to collect falling residual liquid from the sidewall 32 and direct the collected liquid toward the first surface 52. The physical relationship between the first surface 52 and the second surface 54 benefits this functionality. For example, a maximum slope of the first surface 52, which defines the reservoir 56, is greater than a maximum slope of the second surface 54, which acts as a collecting surface. In the exemplary container 30, the slope of one tangent T₃ of the first surface 52 is less than 20 degrees from a longitudinal axis A₁ of the container, or the angle a of the first surface 52 from the horizontal plane is more than 70 degrees. The steep slope of the first surface 52 aggressively directs residual liquid reaching the edge 70 toward the bottom of the reservoir 56. Conversely, the slope of one tangent T₂ of the second surface 54 is more than 70 degrees from a longitudinal axis of the container, or the angle of the second surface 54 from the horizontal plane is less than 20 degrees. The slight slope of the second surface 54 collects falling residual liquid from the sidewalls and directs the residual liquid toward the edge 70, over the edge, and into the reservoir 56. It should be understood by those with skill in the art that these angles are exemplary only, and that the invention may be practiced a first surface and second surface having different shapes, different maximum slopes, and different minimum slopes.

A container may have a bottom wall with a variety of shapes. As discussed herein, the bottom wall defines an inner surface with at least two portions. One portion of the interior surface acts as a collecting portion, to gather residual liquid remaining after a bulk amount of liquid has been removed, and a second portion acts to aggregate the residual fluid into a reservoir, such the residual fluid may be removed by an instrument.

FIG. 5a shows a front sectional view of another container 80. The exemplary container shares similar features of other containers discussed herein. An interior space 86 of the container 80 is accessible through an opening 88. The interior space 86 is formed by a side wall 82 and a bottom wall 100. A threaded portion 96 allows a removable cap to be installed by a user to cover the opening 88. The container 80 may sit upright on a horizontal surface by resting on a flanged bottom 90.

The bottom wall 100 has an interior surface 106 with features which limit the amount of lost residual breast milk. Referring now to FIGS. 5b, the interior surface 106 is defined by at least two portions, a first surface 102 at the center of the container and a second surface 104 near the sidewall of the container. The first surface 102 is arranged to aggregate a residual amount of the liquid after a bulk of the liquid has been removed. The first surface acts to collect residual liquid. In this exemplary container, the first surface 102 defines a reservoir 108 in which residual liquid may be stored for intended use. The reservoir 108 has concave walls relative to the interior space 86. To be discussed herein, the reservoir is advantageously shaped to accept insertion of an instrument to a depth below the level of any aggregated residual liquid.

The second surface 104 is concave relative the interior space 86 and has a generally downward slope toward the first surface 102 for directing a residual amount of the liquid toward the first surface 102. In the exemplary container 80 shown in FIGS. 5a and 5b, the second surface 104 surrounds the first surface 102 and, as best seen in FIG. 5b, the second surface 104 and the reservoir 108 are concentric about a longitudinal axis A₂ of the container. After the bulk of liquid within the interior space 86 is removed by a syringe or other method, residual liquid is forced down the generally vertical sidewall 82 by gravity and onto the second surface 104, which acts as a collecting surface. Gravity will continue to force residual liquid on the collecting surface 104 both downward and inward toward the centrally located reservoir 108.

Similar to other containers discussed herein, the collecting surface 104 and the reservoir-defining surface 102 are separated by an edge. As shown in FIG. 5b, the edge 110 is a rounded shoulder between the two surfaces 102, 104. At the edge 110, the slope of the interior surface 100 increases in a direction toward the first surface 102. In other words, the slope of the interior surface 100 is steeper just to the inward side of the edge 110 as compared to just to the outward side. For example, a point 111 on the second surface has a slope not as steep as a point 112 of the surface of the reservoir 108. This arrangement is further illustrated by the surface tangent of the slope at each point, i.e., tangent T₄ at the edge 110 is clearly more steep than a tangent at point 111 on the collecting surface and less steep then a surface tangent at point 112 on the reservoir surface. As discussed, it should be apparent to one with skill in the art that the invention may be practiced with bottom wall surfaces having slopes and shapes different than the embodiments discussed herein.

A method of use of the invention will now be discussed. Residual fluid aggregated in the reservoir of the container may be removed with an instrument, such as for example, a pipette or a syringe. FIGS. 6a-6b illustrate the removal of residual fluid from a container 30 by an instrument. The same instrument may be used to remove the bulk amount and the residual amount in one process step, or the bulk amount and the residual amount may be removed in two separate process steps, either with the same instrument or with multiple separate instruments.

Referring now to FIG. 6a, a front sectional view of container is shown with a syringe inserted into the container. The instrument is a two part plastic syringe, having a plunger 204 movable within a body 202. As best seen in FIG. 6b, a open-ended tip 206 is formed at the distal end of the syringe 200. The steep wall 58 of the reservoir 56 is shaped to correspond to the outside wall 208 of the tip 206, such that the tip 206 may be inserted into the reservoir. Specifically, the distal end of the tip is insertable to a depth below the residual fluid aggregated in the reservoir. In regard to FIG. 6b, the distal end 210 of the tip 206 is inserted to a depth P₁ below the top level 214 of the residual fluid 212. As the plunger is moved in a upward direction D₁, residual fluid is drawn out of the reservoir to an intermediate level 220, the tip. As can be appreciated by FIG. 6b, and more shallow intermediate level 222, the instrument can be held at a depth such that virtually all of the residual fluid can be removed without loss of suction.

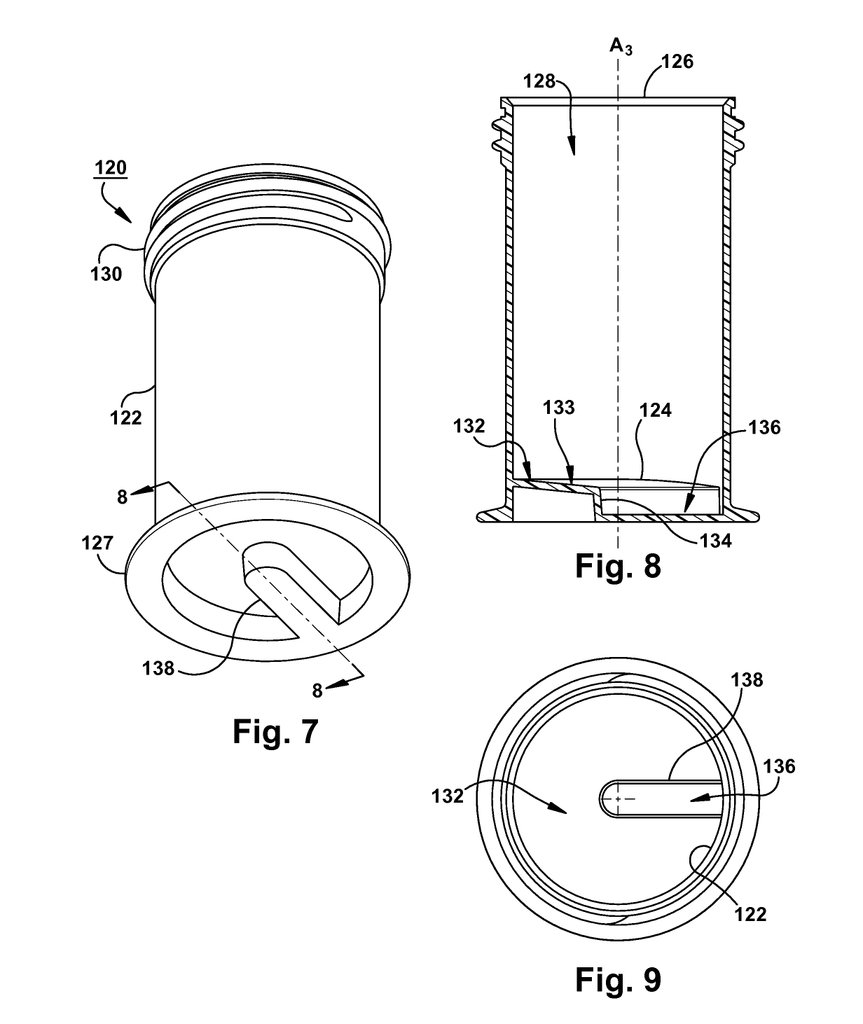

Referring now to FIG. 7, a bottom perspective view of another exemplary container is illustrated. The container 120 has many similar properties to other containers discussed herein, including a sidewall 122, a bottom wall 124 and a flanged base 127. An opening 126 provides user access to an interior space 128 for storage of a liquid. Threads 130 near the opening 126 allow the interior space 128 to be closed by a removable cap. A front sectional view and a top view of the container of FIG. 7 are shown in FIGS. 8 and 9, respectively.

The bottom wall of container has an interior surface with a first surface which is not symmetric or concentric about the longitudinal axis A₃. As shown in FIGS. 8 and 9, the interior surface 133 has two portions, a first surface 136 which defines a reservoir 138, and a second surface 132 which surrounds the majority of the first surface 136. The exemplary container 120 aggregates residual liquid for recovery in a similar way as other embodiments discussed herein. After the bulk of liquid within the interior space 128 is removed by a syringe or other method, residual liquid is forced down the generally vertical sidewall 122 by gravity and either onto the second surface 132, which acts as a collecting surface, or directly into the reservoir 138 along a steep wall 134. In this exemplary container, portions of the sidewall and the reservoir are contiguous. Gravity will continue to force residual liquid on the collecting surface 132 downward toward the reservoir 138.

As seen in the top view of the container 120 in FIG. 9, the reservoir 138 is trough-shaped and extends about half way across the diameter of the bottom wall 124 of the container. In this orientation, the user may rotate the container as it stands upright on a horizontal surface, such that the reservoir may be positioned as preferred by a user, such as for example, at the “three o'clock” position as shown in FIG. 9. A user's preference may vary for many reasons, such as for example, if the user is right-handed or left-handed.

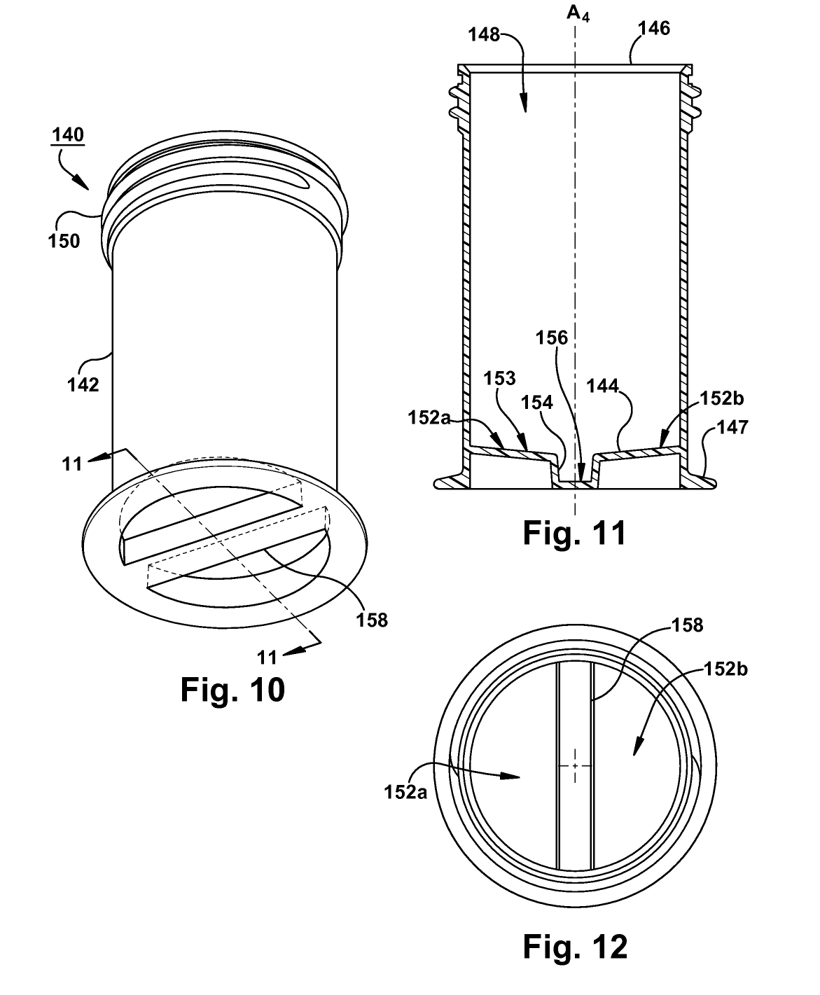

Another exemplary container 140 is illustrated in FIGS. 10-12. The container 140 has many similar properties to container 120 discussed herein, including a sidewall 142, a bottom wall 154 and a flanged base 147. An opening 146 provides user access to an interior space 148 for storage of a liquid. Threads 150 near the opening 146 allow the interior space 148 to be closed by a removable cap. As shown in FIGS. 11 and 12, the interior surface 153 has two portions, a first surface 156 which defines a reservoir 158, and a second surface which surrounds the majority of the first surface 156. In this embodiment, the second surface is formed by two non-contiguous surface 152a, 152b, each placed on opposing sides of the reservoir 158.

The exemplary container 140 aggregates residual liquid for recovery in a similar way as other embodiments discussed herein. After the bulk of liquid within the interior space 148 is removed by a syringe or other method, residual liquid is forced down the generally vertical sidewall 142 by gravity and either onto the second surfaces 152a, 152b, which act as collecting surfaces, or directly into the reservoir 158 along a steep wall 134. In this exemplary container, portions of the sidewall and the reservoir are contiguous. Gravity will continue to force residual liquid on the collecting surfaces 1522, 152b downward toward the reservoir 158. As seen in the top view of the container 120 in FIG. 9, the reservoir 158 is trough-shaped and extends across the entire diameter of the bottom wall 144 of the container.

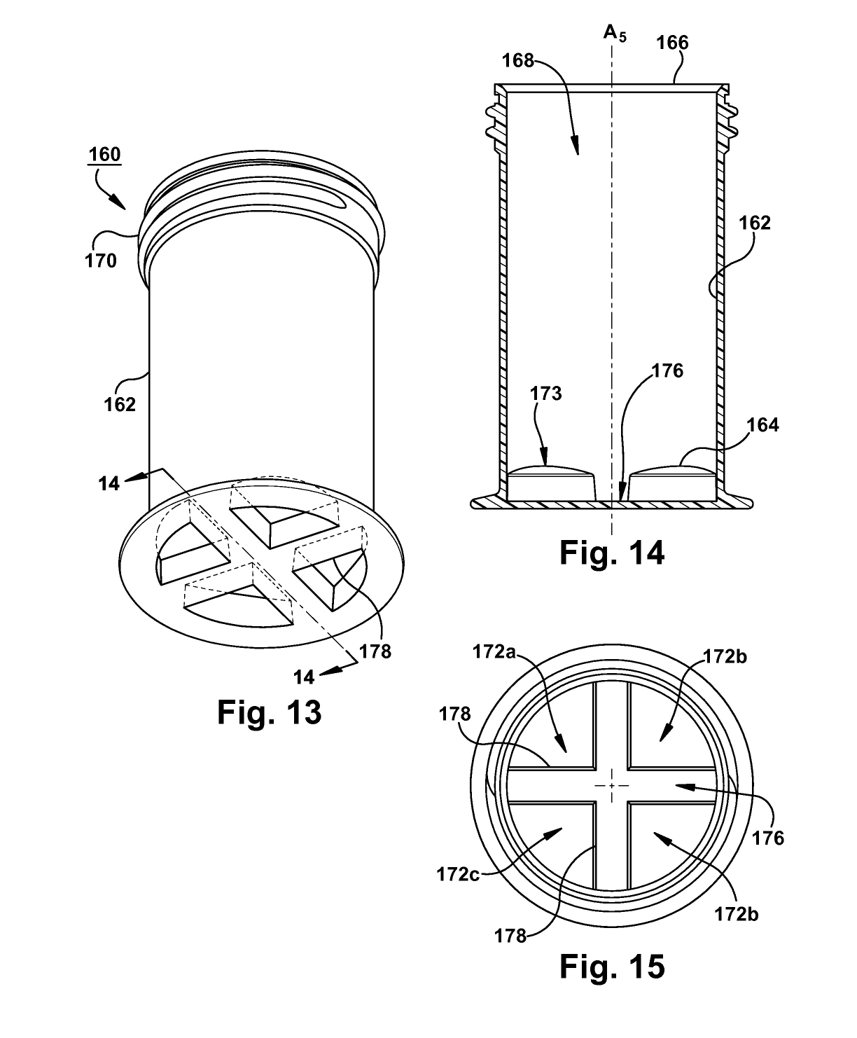

Yet another exemplary container 160 is illustrated in FIGS. 13-15. The container 160 has many similar properties to containers 120, 140 discussed herein, including a sidewall 162, a bottom wall 164, an opening 166, an interior space 168 and threads 170 to accommodate a removable cap. As best shown in FIG. 15, the interior surface 173 has two portions, a first surface 176 which defines a reservoir 178, and a second surface which surrounds the majority of the first surface 176. In this embodiment, the second surface is formed by four non-contiguous surfaces 172a, 172b, 172c, 172d, each placed on opposing sides of the reservoir 178.

The exemplary container 160 aggregates residual liquid for recovery in a similar way as other embodiments discussed herein. After the bulk of liquid within the interior space 168 is removed by a syringe or other method, residual liquid is forced down the generally vertical sidewall 162 by gravity and either onto the second surfaces 172a, 172b, 172c, 172d, which act as collecting surface, or directly into the reservoir 178. In this exemplary container, portions of the sidewall and the reservoir are contiguous. Gravity will continue to force residual liquid on the collecting surface downward toward the reservoir 178. As seen in the top view of the container 160 in FIG. 15, the reservoir 178 is cross-shaped and extends in two perpendicular directions across the entire diameter of the bottom wall 164 of the container. As viewed from the top view of FIG. 15, the interior surface 173 is circle-shaped and the interior surface and the cross-shaped reservoir 178 are concentric.

While various inventive aspects, concepts and features of the general inventive concepts are described and illustrated herein in the context of various exemplary embodiments, these various aspects, concepts and features may be used in many alternative embodiments, either individually or in various combinations and sub-combinations thereof. Unless expressly excluded herein all such combinations and sub-combinations are intended to be within the scope of the general inventive concepts. Still further, while various alternative embodiments as to the various aspects, concepts and features of the inventions (such as alternative materials, structures, configurations, methods, circuits, devices and components, alternatives as to form, fit and function, and so on) may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the general inventive concepts even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

What is claimed is:

1. A container for storage of a liquid, the container comprising:
at least one side wall and a bottom wall defining an interior space, the bottom wall having an interior surface;
wherein the interior surface is defined by at least two portions, a first surface for aggregating a residual amount of the liquid and a second surface having a slope toward the first surface for directing a residual amount of the liquid toward the first surface.

2. The container of claim 1 wherein the first surface and the second surface are separated by an edge.

3. The container of claim 2 wherein a slope of the interior surface increases at the edge in a direction toward the first surface.

4. The container of claim 1 wherein a maximum slope of the first surface is greater than a maximum slope of the second surface.

5. The container of claim 1 wherein a slope of at least one tangent of the first surface is at least 1.5 times the slope of at least one tangent of the second surface.

6. The container of claim 1 wherein a slope of at least one tangent of the first surface is less than 20 degrees from a longitudinal axis of the container.

7. The container of claim 1 wherein a slope of at least one tangent of the second surface is more than 70 degrees from a longitudinal axis of the container.

8. The container of claim 1 wherein the second surface is flat relative the interior space.

9. The container of claim 1 wherein the second surface is concave relative the interior space.

10. The container of claim 1 wherein the second surface surrounds the first surface.

11. The container of claim 1 wherein the first surface defines a reservoir.

12. The container of claim 11 wherein the reservoir is nipple-shaped.

13. The container of claim 12 wherein the interior surface is circle-shaped and the interior surface and the reservoir are concentric.

14. The container of claim 11 wherein the reservoir is cross-shaped.

15. The container of claim 11 wherein the reservoir is a trough.

16. The container of claim 11 wherein the reservoir has a volume of at least 50 micro liters.

17. A sealable container for storage and removal of the liquid, the container comprising:
at least one side wall and a bottom wall defining an interior space, the bottom wall having an interior surface;
wherein the interior surface is defined by at least two portions, a reservoir for aggregating a residual amount of the liquid and a collecting surface for directing a residual amount of the liquid toward the reservoir, wherein the collecting surface is disposed around at least part of the reservoir;
wherein the reservoir and the collecting surface are separated by an edge.

18. The sealable container of claim 17 wherein a slope of the interior surface increases at the edge in a direction toward the reservoir.

19. The sealable container of claim 17 wherein the interior surface and reservoir are circle-shaped and concentric, wherein the collecting surface surrounds the reservoir.

20. The sealable container of claim 17 wherein the collecting surface includes at least two surfaces separated by the reservoir.

21. An system for storage of a liquid, the system comprising:
an instrument having a liquid-receiving opening at a distal end; and
a container having at least one side wall and a bottom wall defining an interior space, the bottom wall having an interior surface;
wherein the interior surface is defined by at least two portions, a reservoir for aggregating a residual amount of liquid and a collecting surface for directing the residual amount of liquid toward the reservoir, wherein the reservoir is shaped to permit entry of the distal end of the instrument;
wherein the reservoir and the collecting surface are separated by an edge, and a slope of the interior surface increases at the edge in a direction toward the reservoir.

22. The system of claim 21 wherein the interior surface and reservoir are circle-shaped and concentric, wherein the collecting surface surrounds the reservoir.
